(19) United States
(12) Patent Application Publication
(10) Pub. No.: US 2013/0280154 A1
(43) Pub. Date: Oct. 24, 2013

(54) APPARATUS AND METHOD FOR TREATING PERFLUORO-COMPOUND

(71) Applicant: GLOBAL STANDARD TECHNOLOGY CO., LTD., Gyeonggi-do (KR)

(72) Inventors: Jong Kook Chung, Gyeonggi-do (KR); Myung Ki Chae, Gyeonggi-do (KR); Jae Doo Jeon, Chungcheongbuk-do (KR); Jong Chul Kim, Gyeonggi-do (KR)

(73) Assignee: Global Standard Technology Co., Ltd., Gyeonggi-do (KR)

(21) Appl. No.: 13/726,262

(22) Filed: Dec. 24, 2012

(30) Foreign Application Priority Data
Apr. 23, 2012 (KR) 10-2012-0042062

(51) Int. Cl. B01D 53/68

(52) U.S. Cl. CPC B01D 53/685
USPC 423/240 S; 422/170; 422/162

(57) ABSTRACT

The present invention discloses an apparatus and method for treating perfluoro-compounds (PFCs). The method for treating PFCs includes: (a) decomposing PFCs and eliminating a first acid gas generated by the decomposition through a pre-cleaner; (b) filtering out dust particles from the exhaust gas through a filter; (c) electrifying the dust particles in the exhaust gas by electrical discharge and collecting dusts through a dust collector; (d) decomposing PFCs using a regenerative/catalytic reaction through a catalytic reactor; (e) eliminating a second acid gas generated by the regenerative/catalytic reaction through a post-cleaner; and (f) letting the purified exhaust gas out through a fan.

### CROSS-REFERENCE TO RELATED APPLICATION

This application is based on and claims priority from Korean Patent Application No. 10-2012-0042062, filed on Apr. 23, 2012 in the Korean Intellectual Property Office, the disclosure of which is incorporated herein in its entirety by reference.

### BACKGROUND OF THE INVENTION

1. Field of the Invention

The present invention relates to an apparatus and method for treating perfluoro-compounds and, more particularly to an apparatus and method for treating perfluoro-compounds contained in an exhaust gas emitted from the semiconductor processing facility.

2. Background Art

Generally, the etching, washing, or deposition process in the manufacture of LCD or OLED, including semiconductors, involves supplying a processing gas into a closed processing chamber, allowing the gas to react on a substrate (material). The processing gas is mostly perfluoro-compound (PFC) gases, such as CF₄, C₂F₆, C₃F₈, NF₃, SF₆, etc.

However, these PFC-based gases exist in the air without decomposition due to their bonding characteristic and act as a main cause of environmental pollution, particularly resulting in global warming. Accordingly, a purification process is necessary before the release of the PFC-based gases into the air.

### SUMMARY OF THE INVENTION

It is therefore an object of the present invention to provide an apparatus for treating perfluoro-compounds that is capable of accomplishing a large-scale purification process and being installed outdoors, and a method for treating perfluoro-compounds using the apparatus.

The object of the present invention is not specifically limited hereto, and other objects may be definitely understood by those skilled in the art from the description as follows.

To accomplish the above object of the present invention, there is provided an apparatus for treating a perfluoro-compound, which apparatus is to purify an exhaust gas containing a perfluoro-compound, the apparatus comprising: a pre-cleaner for decomposing the perfluoro-compound and removing a first acid gas produced by the decomposition; a filter for filtering out dust particles contained in the exhaust gas; a dust-collector for electrifying the dust particles contained in the exhaust gas by electrical discharge and collecting dusts; a catalytic reactor for decomposing the perfluoro-compound through a regenerative/catalytic reaction; a post-cleaner for eliminating a second acid gas generated by the regenerative/catalytic reaction; and a fan for letting the exhaust gas out. The pre-cleaner, the filter, the dust-collector, the catalytic reactor, the post-cleaner, and the fan are arranged in series and sequentially put into operation.

According to the embodiment of the present invention, the pre-cleaner, the filter, the dust-collector, the catalytic reactor, the post-cleaner, and the fan may be arranged outside a clean room equipped with devices for performing a semiconductor process.

According to the embodiment of the present invention, the pre-cleaner comprises first and second pre-treatment wet scrubbers arranged in series. The first and second pre-treatment wet scrubbers independently comprise: a housing provided with an inlet opening for the exhaust gas on the bottom end thereof and an outlet opening for the exhaust gas on the top end thereof; a spray for supplying water into the housing; a filler member disposed inside the housing for increasing a contact area between the exhaust gas and the water to allow decomposition of the perfluoro-compound contained in the exhaust gas with the water and absorption of the first acid gas by the water; and a mist removing member arranged on the top of the filler member to remove a mist of the first acid gas.

According to the embodiment of the present invention, the filter comprises a wet filter made of any one material selected from a fiber-reinforced plastic, a polyvinyl chloride (PVC) resin, a polytetrafluoroethylene (PTFE) resin, Inconel, and S.T.S.

According to the embodiment of the present invention, the dust-collector comprises first and second electric dust-collectors arranged in parallel between the filter and the catalytic reactor. The first and second electric dust-collectors independently comprise: a housing provided with an inlet opening for the exhaust gas on the bottom end thereof and an outlet opening for the exhaust gas on the top end thereof; a filler member disposed inside the housing; a plurality of dust-collecting plates having a cylindrical shape with top and bottom open, and being arranged on the top of the filler member; a plurality of discharge rods each disposed inside the respective dust-collecting plates; and a power supply member for applying power to the dust-collecting plates and the discharge rods.

According to the embodiment of the present invention, the catalytic reactor comprises: a housing providing an inlet opening and an outlet opening for the exhaust gas; a catalyst member disposed inside the housing and used to decompose the perfluoro-compound; a pre-heating member disposed under the catalyst member and used to pre-heat the exhaust gas; and a heating member disposed over the catalyst member and used to heat the catalyst member to a processing temperature.

According to the embodiment of the present invention, the post-cleaner comprises first and second post-treatment wet scrubbers arranged in series. The first post-treatment wet scrubber eliminates the second acid gas using an alkaline solution, and the second post-treatment wet scrubber eliminates the alkaline solution and the second acid gas using water.

According to the embodiment of the present invention, the first post-treatment wet scrubber comprises: a first housing provided with an inlet opening for the exhaust gas on the bottom end thereof and an outlet opening for the exhaust gas on the top end thereof; a first spray for supplying the alkaline solution into the first housing; a first filler member disposed inside the first housing for increasing a contact area between the second acid gas contained in the exhaust gas and the alkaline solution; and a first mist removing member arranged on the top of the first filler member and used to remove a mist of the second acid gas.

According to the embodiment of the present invention, the second post-treatment wet scrubber comprises: a second housing provided with an inlet opening for the exhaust gas on the bottom end thereof and an outlet opening for the exhaust gas on the top end thereof; a second spray for supplying the water into the second housing; a second filler member disposed inside the second housing for increasing a contact area between the second acid gas and an alkaline gas contained in the exhaust gas and the water; and a second mist removing member arranged on the top of the second filler member and used to remove a mist of the second acid gas and the alkaline gas.

To achieve the object of the present invention, there is provided a method for treating a perfluoro-compound, which method is to purify an exhaust gas containing a perfluoro-compound, the method comprising: (a) decomposing the perfluoro-compound using water and eliminating a first acid gas generated by the decomposition; (b) filtering out dust particles from the exhaust gas removed of the first acid gas; (c) electrifying the filtered dust particles in the exhaust gas by electrical discharge and collecting dusts; (d) decomposing the perfluoro-compound through a regenerative/catalytic reaction; (e) eliminating a second acid gas generated by the regenerative/catalytic reaction; and (f) letting the purified exhaust gas out.

According to the embodiment of the present invention, the step (a) is repeatedly conducted multiple times.

According to the embodiment of the present invention, the step (e) comprises: eliminating the second acid gas using an alkaline solution; and eliminating an alkaline gas of the alkaline solution and the remainder of the second acid gas using water.

According to the embodiment of the present invention, the step (d) comprises: pre-heating the exhaust gas; supplying water vapor for the pre-heated exhaust gas; heating a catalyst layer at a processing temperature; and allowing the catalyst layer to decompose the perfluoro-compound contained in the exhaust gas.

According to the present invention, the apparatus for treating a perfluoro-compound that is mounted outdoors can be used to accomplish large-scale purification of an exhaust gas containing perfluoro-compounds.

### BRIEF DESCRIPTION OF THE DRAWINGS

The under-mentioned drawings are given for illustration only and not intended to limit the scope of the present invention.

FIG. 1 is a flow chart showing a method for treating a perfluoro-compound according to an embodiment of the present invention.

FIG. 2 is a perspective view of an apparatus for treating a perfluoro-compound according to an embodiment of the present invention.

FIG. 3 is a partial perspective view showing a first pre-treatment wet scrubber of FIG. 2.

FIG. 4 is a partial perspective view showing a first electric dust-collector of FIG. 2.

FIG. 5 is a partial perspective view showing a catalytic reactor of FIG. 2.

FIG. 6 is a partial perspective view showing a first post-treatment wet scrubber of FIG. 2.

### DETAILED DESCRIPTION OF THE PREFERRED EMBODIMENT

Hereinafter, a detailed description will be given as to an apparatus and method for treating a perfluoro-compound according to a preferred embodiment of the present invention with reference to the accompanying drawings. Throughout the drawings, like reference letters indicate corresponding parts in the various figures. Further, detailed descriptions of well-known components or functions may be omitted so as not to unnecessarily obscure the embodiments disclosed herein.

### Example

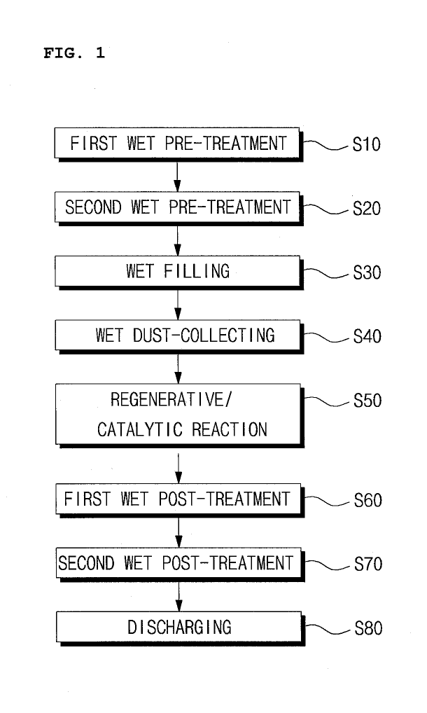

FIG. 1 is a flow chart showing a method for treating a perfluoro-compound according to one embodiment of the present invention. Referring to FIG. 1, the treatment method for perfluoro-compounds (PFCs) is directed to a method of purifying PFCs contained in an exhaust gas emitted from, for example, a semiconductor manufacturing device.

The PFCs are used in the etching, cleaning, or deposition process of the semiconductor processing and may include any one processing gas, such as, for example, CF₄, SF₆, NF₃, C₂F₆, C₃F₈, CHF₃, etc.

The treatment method for PFCs comprises a first wet pre-treatment step S10, a second wet pre-treatment step S20, a wet filtering step S30, a wet dust-collecting step S40, a regenerative/catalytic reaction S50, a first wet post-treatment step S60, a second wet post-treatment step S70, and a discharging step S80, which steps S10 to S80 are sequentially conducted in succession.

In the first wet pre-treatment step S10, PFCs contained in the exhaust gas are decomposed by a wet method using water (H₂O), and the acid gas generated from the decomposition is absorbed by the water (H₂O). The decomposition mechanism, where the PFC is CF₄, for example, can be described as follows.

CF₄+2H₂O→CO₂+4HF

A contact between CF₄+2H₂O causes the above reaction, where CF₄ is decomposed into CO₂ and HF (acid gas), and the HF (acid gas) is absorbed by water (H₂O). Part of the dust particles contained in the exhaust gas are washed away or eliminated by water.

In the second wet pre-treatment step S20, the same procedures of the first wet pre-treatment step S10 are conducted to pre-treat the PFCs in the exhaust gas.

The wet filtering step S30 is filtering out the dust particles contained in the exhaust gas removed of the acid gas through the first and second wet pre-treatment steps. Here, a wet washing filter can be used for filtering out the dust particles.

In the wet dust-collecting step S40, the filtered dust particles of the exhaust gas are electrically charged by Corona discharge and collected and removed by dust-collecting plates.

In the regenerative/catalytic reaction S50, the PFCs in the exhaust gas are decomposed by a regenerative/catalytic reaction. First, the exhaust gas containing PFCs is pre-heated and supplied with water vapor, and the catalyst layer is heated to a processing temperature. Meantime, the PFCs are subjected to decomposition by the catalyst layer. The decomposition using the catalyst layer generates an acid gas, which is eliminated in the subsequent first wet post-treatment step S60.

The first wet post-treatment step S60 is eliminating the acid gas generated from the regenerative/catalytic reaction of PFCs. The acid gas can be removed through a reaction with an alkaline solution, such as of NaOH or KOH.

In the second wet post-treatment step S70, a wet method using water (H₂O) is employed to eliminate the alkaline gas resulting from the alkaline solution used in the first wet post-treatment step S60 and the remainder of the acid gas not eliminated in the first wet post-treatment step S60.

The discharging step S80 is to let out the exhaust gas removed of the PFCs through the steps S10 to S70.

Hereinafter, a description will be given as to a treatment apparatus for PFCs used in the above-described treatment method for PFCs.

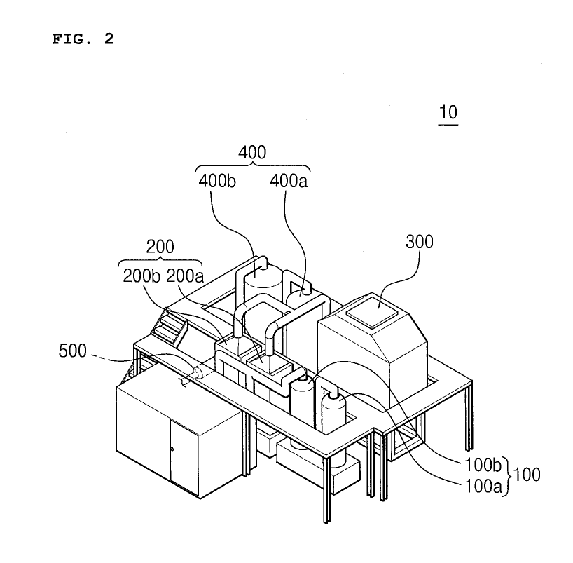

FIG. 2 is a perspective view of an apparatus for treating PFCs according to an embodiment of the present invention. Referring to FIG. 2, the PFC treatment apparatus 10 may be installed outdoors, that is, outside a clean room equipped with semiconductor processing devices.

The PFC treatment apparatus 10 comprises a pre-cleaner 100, a filter (not shown), a dust collector 200, a catalytic reactor 300, a post-cleaner 400, and a fan 500, which components are arranged in series and put into operation in sequence.

The pre-cleaner 100 comprises first and second pre-treatment wet scrubbers 100a and 100b arranged in series. The first pre-treatment wet scrubber 100a receives the exhaust gas emitted from the semiconductor processing devices and conducts the first wet pre-treatment step S10 of FIG. 1 for the exhaust gas. The second pre-treatment wet scrubber 100b is arranged serially at the rear end of the first pre-treatment wet scrubber 100a to conduct the second wet pre-treatment step S20 of FIG. 1 for the exhaust gas.

The filter (not shown) is arranged serially at the rear end of the second pre-treatment wet scrubber 100b to conduct the wet filtering step S30 of FIG. 1 for the exhaust gas. The filter (not shown) may be a wet filter made of any one material selected from a fiber-reinforced plastic (FRP), a polyvinyl chloride (PVC) resin, a polytetrafluoroethylene (PTFE) resin, Inconel, and S.T.S.

The dust collector 200 comprises first and second electric dust collectors 200a and 200b arranged in parallel between the filter (not shown) and the catalytic reactor 300. The first and second electric dust collectors 200a and 200b conduct the wet dust-collecting step S40 of FIG. 1 for the exhaust gas.

The catalytic reactor 300 is arranged serially at the rear end of the first and second electric dust collectors 200a and 200b to conduct the regenerative/catalytic reaction step S50 of FIG. 1 for the exhaust gas.

The post-cleaner 400 comprises first and second post-treatment wet scrubbers 400a and 400b connected in series to each other. The first post-treatment wet scrubber 400a is arranged serially at the rear end of the catalytic reactor 300 to conduct the first wet post-treatment step S60 of FIG. 1 for the exhaust gas received from the catalytic reactor 300. The second post-treatment wet scrubber 400b is arranged serially at the rear end of the first post-treatment wet scrubber 400a to conduct the second wet post-treatment step S70 of FIG. 1 for the exhaust gas.

The fan 500 is arranged serially at the rear end of the second post-treatment wet scrubber 400b to conduct the discharging step S80 of FIG. 1 for the finally purified exhaust gas.

The term “rear end’ as used herein does not refer to the rear position in spatial arrangement but means the subsequent position in the process order based on the flow of processing the exhaust gas to be purified.

Hereinafter, a detailed description will be given as to the construction of the first pre-treatment wet scrubber 100a, the first electric dust collector 200a, the catalytic reactor 300, and the first post-treatment wet scrubber 400a.

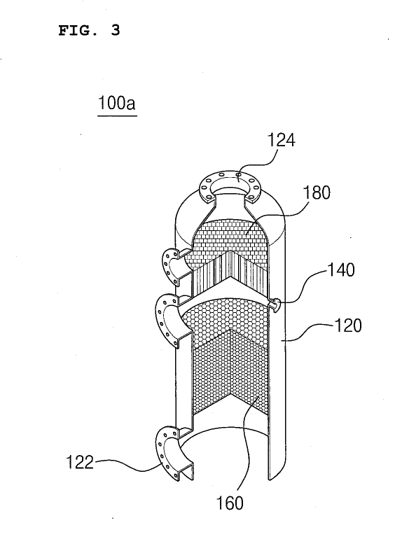

FIG. 3 is a partial perspective view of the first pre-treatment wet scrubber of FIG. 2. Referring to FIGS. 2 and 3, the first and second pre-treatment wet scrubbers 100a and 100b have the same construction, and a description will be given only as to the first pre-treatment wet scrubber 100a other than the second pre-treatment wet scrubber 100b.

The first pre-treatment wet scrubber 100a comprises a housing 120, a spray 140, a filter 160, and a mist removing member 180. The housing 120 is generally formed in a cylindrical shape and provided with an inlet opening 122 for the exhaust gas on its bottom end and an outlet opening 124 for the exhaust gas pre-treated by the first pre-treatment wet scrubber 100a on its top end.

The spray 140 is provided on the sidewall of the housing 120 to supply water (H₂O) for decomposition of PFCs in the exhaust gas into the housing 120. The filler member 160 is arranged inside the housing 120 to be under the spray 140 and used to increase a contact area between the exhaust gas incident through the inlet opening 122 and the water supplied by the spray 140. Such an increase in the contact area between the exhaust gas and the water facilitates decomposition of PFCs in the exhaust gas with water and increases the contact between the acid gas generated from the decomposition with water to accelerate the removal of the acid gas. The mist removing member 180 is arranged inside the housing 120 to be above the spray 140 and used to eliminate the mist of the acid gas, which is a gas generated from the decomposition. The exhaust gas removed of the acid gas and the mist is let out through the outlet opening 124.

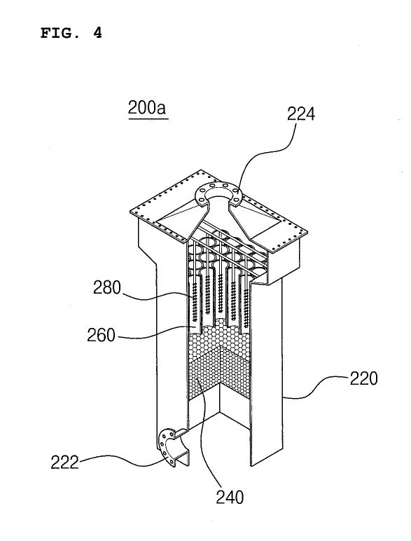

FIG. 4 is a partial perspective view of the first electric dust collector of FIG. 2. Referring to FIGS. 2 and 4, the first and second electric dust collectors 200a and 200b have the same construction, and a description will be given only as to the first electric dust collector 200a other than the second electric dust collector 200b.

The first electric dust collector 200a comprises a housing 220, a filler member 240, dust-collecting plates 260, and discharge rods 280. The housing 220 is generally formed in a cylindrical shape with a rectangular cross-section. The housing 220 is provided with an inlet opening 222 on its bottom end to let the exhaust gas in and an outlet opening 224 on its top end to let out the exhaust gas removed of dust particles by the first electric dust collector 200a.

A spray (not shown) is provided on the sidewall of the housing 220, and the filter 240 is disposed inside the housing 120 to be under the spray 140. The filler member 240 conducts the same function as the filler member 160 of the first pre-treatment wet scrubber 100a shown in FIG. 3.

The dust-collecting plates 260 and the discharge rods 280 are arranged inside the housing 220 to be on the top of the filler member 240. The dust-collecting plates 260 are generally formed in a cylindrical shape with top and bottom open and aligned to have the same lengthwise direction of the housing 220. The dust-collecting plates 260 are arranged on the plane perpendicular to the lengthwise direction of the housing 220. The discharge rods 280 are generally formed in a rod shape and inserted into the inner space of the respective dust-collecting plates 260.

The exhaust gas enters the space between the dust-collecting plates 260 and the discharge rods 280. Upon application of electrical power for Corona discharge to the dust-collecting plates 260 and the discharge rods 280, a discharge occurs to electrify the dust particles of the exhaust gas with negative (−) charges, so the dust particles taking negative (−) charges are attracted towards the inner wall of the dust-collecting plates 260 taking positive (−) charges. Water is supplied on the inner wall of the dust-collecting plates 260 and used to wash away the dust particles collected on the inner wall of the dust-collecting plates 260. The exhaust gas removed of the dust particles is let out through the outlet opening 224.

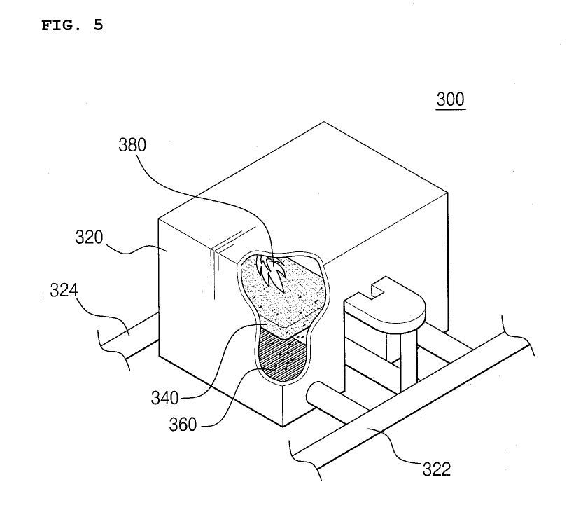

FIG. 5 is a partial perspective of the catalytic reactor of FIG. 2. Referring to FIG. 5, the catalytic reactor 300 is a two-bed type reactor with two partitioned compartments. The catalytic reactor 300 may be partitioned into at least three compartments.

Each compartment is defined by a housing 320, which contains a catalyst member 340, a pre-heating member 360, and a heating member 380. The outer wall of the housing 320 is connected to an inlet pipe 322 to let the exhaust gas in, and an outlet pipe 324 to let the exhaust gas out.

The catalyst member 340 is disposed at the center inside the housing 320 to decompose PFCs of the exhaust gas through a catalytic reaction. The pre-heating member 360 is disposed under the catalyst member 340 to pre-heat the exhaust gas supplied through the inlet pipe 322. The heating member 380 is disposed over the catalyst member 340 to heat the catalyst member 340 to a predetermined processing temperature.

The exhaust gas fed into the housing 320 is pre-heated by the pre-heating member 360 and supplied with water vapor by a water vapor supplying member (not shown). The catalyst member 340 is heated to a predetermined processing temperature by the heating member 380. Then, the PFCs contained in the exhaust gas are decomposed by the catalyst member 340. During the decomposition reaction, an acid gas is generated and then eliminated by the under-mentioned first post-treatment wet scrubber 400a.

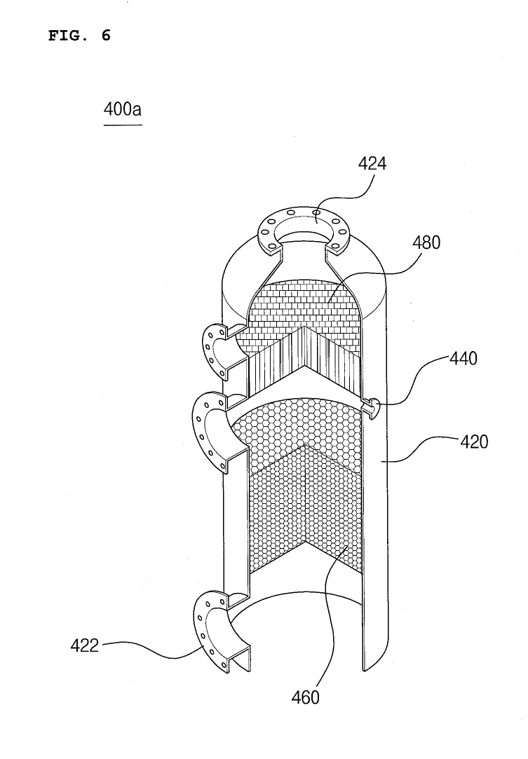

FIG. 6 is a partial perspective of the first post-treatment wet scrubber of FIG. 2. Referring to FIGS. 2 and 6, the first post-treatment wet scrubber 400a comprises a housing 420, a spray 440, a filler member 460, and a mist removing member 480. The housing 420 is generally formed in a cylindrical shape and provided with an inlet opening 422 on its bottom end to let the exhaust gas in and an outlet opening 424 on its top end to let out the exhaust gas post-treated by the first post-treatment wet scrubber 400a.

The spray 440 is provided on the sidewall of the housing 420 to provide the housing 420 with an alkaline solution for eliminating the acid gas generated from the catalytic reactor 300. The alkaline solution may be a solution of NaOH, KOH, or KI. The filler member 460 is arranged inside the housing 420 to be under the spray 440 and used to increase a contact area between the acid gas and the alkaline solution supplied through the spray 440. The mist removing member 480 is arranged inside the housing 420 to be above the spray 440 and used to eliminate the mist of the acid gas. The exhaust gas removed of the acid gas and the mist is let out through the outlet opening 424 and then transferred to the second post-treatment wet scrubber 400b.

The second post-treatment wet scrubber 400b is constructed in the same manner as described in the first post-treatment wet scrubber 400a, excepting that a spray (not shown) is used to supply water (H₂O) rather than the alkaline solution, and its detailed description will be omitted.

The second post-treatment wet scrubber 400b uses water (H₂O) to remove the exhaust gas of the alkaline gas generated from the alkaline solution used in the first post-treatment wet scrubber 400a and the remaining acid gas. The finally purified exhaust gas from the second post-treatment wet scrubber 400b is let out via the fan 500.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner. The scope of the present disclosure is defined by the following claims rather than by the detailed description of the embodiment. It shall be understood that all modifications and embodiments conceived from the meaning and scope of the claims and their equivalents are included in the scope of the present disclosure.

Description of reference numerals of
principal elements in the drawings

| | |
|---|---|
| 100: PRE-CLEANER | 200: DUST COLLECTOR |
| 300: CATALYTIC REACTOR | 400: POST-CLEANER |
| 500: FAN | |

What is claimed is:

1. An apparatus for treating a perfluoro-compound, which apparatus is to purify an exhaust gas containing a perfluoro-compound, the apparatus comprising:
a pre-cleaner for decomposing the perfluoro-compound and removing a first acid gas produced by the decomposition;
a filter for filtering out dust particles contained in the exhaust gas;
a dust-collector for electrifying the dust particles contained in the exhaust gas by electrical discharge and collecting dusts;
a catalytic reactor for decomposing the perfluoro-compound through a regenerative/catalytic reaction;
a post-cleaner for eliminating a second acid gas generated by the regenerative/catalytic reaction; and
a fan for letting the exhaust gas out,
wherein the pre-cleaner, the filter, the dust-collector, the catalytic reactor, the post-cleaner, and the fan are arranged in series and sequentially put into operation.

2. The apparatus as claimed in claim 1, wherein the pre-cleaner, the filter, the dust-collector, the catalytic reactor, the post-cleaner, and the fan are arranged outside a clean room equipped with devices for performing a semiconductor process.

3. The apparatus as claimed in claim 1, wherein the pre-cleaner comprises first and second pre-treatment wet scrubbers arranged in series,
wherein the first and second pre-treatment wet scrubbers independently comprise:
a housing provided with an inlet opening for the exhaust gas on the bottom end thereof and an outlet opening for the exhaust gas on the top end thereof;
a spray for supplying water into the housing;
a filler member disposed inside the housing for increasing a contact area between the exhaust gas and the water to allow decomposition of the perfluoro-compound contained in the exhaust gas with the water and absorption of the first acid gas by the water; and
a mist removing member arranged on the top of the filler member to remove a mist of the first acid gas.

4. The apparatus as claimed in claim 1, wherein the filter comprises a wet filter made of any one material selected from a fiber-reinforced plastic, a polyvinyl chloride (PVC) resin, a polytetrafluoroethylene (PTFE) resin, Inconel, and S.T.S.

5. The apparatus as claimed in claim 1, wherein the dust-collector comprises first and second electric dust-collectors arranged in parallel between the filter and the catalytic reactor,
wherein the first and second electric dust-collectors independently comprise:
a housing provided with an inlet opening for the exhaust gas on the bottom end thereof and an outlet opening for the exhaust gas on the top end thereof;
a filler member disposed inside the housing;
a plurality of dust-collecting plates having a cylindrical shape with the top and bottom thereof open, and being arranged on the top of the filler member;
a plurality of discharge rods each disposed inside the respective dust-collecting plates; and
a power supply member for applying power to the dust-collecting plates and the discharge rods.

6. The apparatus as claimed in claim 1, wherein the catalytic reactor comprises:
a housing providing an inlet opening and an outlet opening for the exhaust gas;
a catalyst member disposed inside the housing and used to decompose the perfluoro-compound;
a pre-heating member disposed under the catalyst member and used to pre-heat the exhaust gas; and
a heating member disposed over the catalyst member and used to heat the catalyst member to a processing temperature.

7. The apparatus as claimed in claim 1, wherein the post-cleaner comprises first and second post-treatment wet scrubbers arranged in series,
wherein the first post-treatment wet scrubber eliminates the second acid gas using an alkaline solution, the second post-treatment wet scrubber eliminating the alkaline solution and the second acid gas using water.

8. The apparatus as claimed in claim 7, wherein the first post-treatment wet scrubber comprises:
a first housing provided with an inlet opening for the exhaust gas on the bottom end thereof and an outlet opening for the exhaust gas on the top end thereof;
a first spray for supplying the alkaline solution into the first housing;
a first filler member disposed inside the first housing for increasing a contact area between the second acid gas contained in the exhaust gas and the alkaline solution; and
a first mist removing member arranged on the top of the first filler member and used to remove a mist of the second acid gas.

9. The apparatus as claimed in claim 8, wherein the second post-treatment wet scrubber comprises:
a second housing provided with an inlet opening for the exhaust gas on the bottom end thereof and an outlet opening for the exhaust gas on the top end thereof;
a second spray for supplying the water into the second housing;
a second filler member disposed inside the second housing for increasing a contact area between the second acid gas and an alkaline gas contained in the exhaust gas and the water; and
a second mist removing member arranged on the top of the second filler member and used to remove a mist of the second acid gas and the alkaline gas.

10. A method for treating a perfluoro-compound, which method is to purify an exhaust gas containing a perfluoro-compound, the method comprising:
(a) decomposing the perfluoro-compound using water and eliminating a first acid gas generated by the decomposition;
(b) filtering out dust particles from the exhaust gas removed of the first acid gas;
(c) electrifying the filtered dust particles in the exhaust gas by electrical discharge and collecting dusts;
(d) decomposing the perfluoro-compound through a regenerative/catalytic reaction;
(e) eliminating a second acid gas generated by the regenerative/catalytic reaction; and
(f) letting the purified exhaust gas out.

11. The method as claimed in claim 10, wherein the step (a) is repeatedly conducted multiple times.

12. The method as claimed in claim 10, wherein the step (e) comprises:
eliminating the second acid gas using an alkaline solution; and
eliminating an alkaline gas of the alkaline solution and the remainder of the second acid gas using water.

13. The method as claimed in claim 10, wherein the step (d) comprises:
pre-heating the exhaust gas;
supplying water vapor for the pre-heated exhaust gas;
heating a catalyst layer at a processing temperature; and
allowing the catalyst layer to decompose the perfluoro-compound contained in the exhaust gas.

14. The apparatus as claimed in claim 2, wherein the pre-cleaner comprises first and second pre-treatment wet scrubbers arranged in series,
wherein the first and second pre-treatment wet scrubbers independently comprise:
a housing provided with an inlet opening for the exhaust gas on the bottom end thereof and an outlet opening for the exhaust gas on the top end thereof;
a spray for supplying water into the housing;
a filler member disposed inside the housing for increasing a contact area between the exhaust gas and the water to allow decomposition of the perfluoro-compound contained in the exhaust gas with the water and absorption of the first acid gas by the water; and
a mist removing member arranged on the top of the filler member to remove a mist of the first acid gas.

15. The apparatus as claimed in claim 2, wherein the filter comprises a wet filter made of any one material selected from a fiber-reinforced plastic, a polyvinyl chloride (PVC) resin, a polytetrafluoroethylene (PTFE) resin, Inconel, and S.T.S.

16. The apparatus as claimed in claim 2, wherein the dust-collector comprises first and second electric dust-collectors arranged in parallel between the filter and the catalytic reactor,
wherein the first and second electric dust-collectors independently comprise:
a housing provided with an inlet opening for the exhaust gas on the bottom end thereof and an outlet opening for the exhaust gas on the top end thereof;
a filler member disposed inside the housing;
a plurality of dust-collecting plates having a cylindrical shape with the top and bottom thereof open, and being arranged on the top of the filler member;
a plurality of discharge rods each disposed inside the respective dust-collecting plates; and
a power supply member for applying power to the dust-collecting plates and the discharge rods.

17. The apparatus as claimed in claim 2, wherein the catalytic reactor comprises:
a housing providing an inlet opening and an outlet opening for the exhaust gas;
a catalyst member disposed inside the housing and used to decompose the perfluoro-compound;
a pre-heating member disposed under the catalyst member and used to pre-heat the exhaust gas; and
a heating member disposed over the catalyst member and used to heat the catalyst member to a processing temperature.

18. The apparatus as claimed in claim 2, wherein the post-cleaner comprises first and second post-treatment wet scrubbers arranged in series,
wherein the first post-treatment wet scrubber eliminates the second acid gas using an alkaline solution, the second post-treatment wet scrubber eliminating the alkaline solution and the second acid gas using water.
